(19) United States
(12) Patent Application Publication
(10) Pub. No.: US 2011/0236572 A1
(43) Pub. Date: Sep. 29, 2011

(54) POLYMER COMPOSITION

(75) Inventors: Jonni Ahlgren, Espoo (FI); Nina Bruun, Helsinki (FI); Vesa Nuutinen, Helsinki (FI)

(73) Assignee: KEMIRA OYJ, Helsinki (FI)

(21) Appl. No.: 13/130,876

(22) PCT Filed: Nov. 23, 2009
(86) PCT No.: PCT/FI2009/050947

§ 371 Date: May 24, 2011

(30) Foreign Application Priority Data
Nov. 24, 2008 (FI) 20086122

(51) Int. Cl. C09D 133/06; C08F 220/10; C08K 3/10; C08K 3/26; C08K 3/34; C08K 3/30; C08K 3/22; C08F 2/22; B05D 1/12; B82Y 30/00

(52) U.S. Cl. 427/180; 526/318.45; 428/402; 524/562; 524/437; 524/427; 524/442; 524/423; 524/451; 524/449; 524/445; 524/432; 524/547; 524/745; 977/773

(57) ABSTRACT

A dry coating binder includes a polymer which includes at least 80% by weight of main monomers. The main monomers are selected from C₁-C₂₀-alkyl (meth)acrylates, C₁-C₂₀-hydroxy alkyl (meth)acrylates, vinyl esters of carboxylic acids including up to 20 carbon atoms, vinyl aromatics having up to 20 carbon atoms, ethylenically unsaturated nitriles, vinyl ethers of alcohols including 1 to 10 carbon atoms, aliphatic hydrocarbons having 2 to 8 carbon atoms and one or two double bonds or mixtures of these monomers, and that the particle size of the binder is between 200-400 nm. Further, the use of the dry coating binder, and a dry coating composition are also described.

### FIELD OF THE INVENTION

The present invention is in the field of paper coating materials. The invention relates to a binder composition comprising copolymer particles. The present invention further concerns the use of the binder composition in coating powders suitable for dry coating systems.

### BACKGROUND OF THE INVENTION

Conventional paper coatings are applied on a paper substrate as water containing coating colors. These coating formulations are prepared by mixing solids of suitable properties, such as inorganic pigments, binders and additives, with water.

Because the conventional coating mixes are applied on the surface of the paper web as water-based slurry, the water carried over to the web by the coating mix must be removed and therefore effective drying is needed after coating. The higher the web speed, the higher drying capacity is needed and the longer becomes the dryer section. Drying is also an energy-intensive process and the investment costs of a dryer section are high.

The above described problem with the water containing coatings can be avoided by a dry surface treatment process in which dry coating powder is applied on a web. For example WO 2004/044323 (Metso Paper Inc.) discloses a method for coating a web of paper by a dry coating powder. The method comprises the step of applying the coating powder to at least one side of the moving web. The coating powders include inorganic materials and polymeric binder material.

The dry surface treatment technology is still under development. Especially the coating materials used need to be improved. Many different kinds of coating compositions are known from the prior art. US 2005/0006041 (Omya Ag) discloses a composite compositions of co-structured or co-adsorbed fillers containing at least two different types of minerals or organic pigments and their use in papermaking for the coating. This composition contains at least one pigment having a surface with at least one hydrophilic site and at least one pigment having at least one organophilic site. The binder of this composition is selected from the group containing acrylic polymers, vinyl polymers, their copolymers, their polycondensates, or the polyaddition products, in their free acid state or partially neutralized, or totally neutralized, of at least one of the monomers acrylic acid, methacrylic acid etc.

WO 01/00712 (Neste Chemicals Oy) discloses dry pigment granulates for paper coating, especially for fine paper. The pigment granulate comprises 95-99.5 wt-% of organic polymer pigment, 0-94.5 wt-% of inorganic pigment and 0.5-5 wt-% of a binder or a mixture of binders and the particle size of the granulate is 4-400 μm. Polyvinyl alcohol, polyvinylacetate, styrene-butadiene latex, polyethylene glycol, and similar compounds are mentioned as examples of suitable binders. This publication does not contain any teaching regarding the particle size of the binder before mixing with the pigment.

WO 2006/050873 (Basf Ag) discloses a paper coating slip containing at least one inorganic pigment, in particular white pigments, and, in relation to 100 weight parts of the inorganic pigments, less than 40 weight parts of organic polymers, and less than 25 weight parts of water or other solvents with a boiling point lower than 150° C. at 1 bar. The paper coating slips should have as low content as possible of water or solvents and they should adhere well to paper. The binder used in the slip can be a polymer prepared by emulsion polymerization, such as Acronal® S 728, which is an aqueous dispersion of a styrene/butyl acrylate copolymer.

An article by Peter C. Hayes “Styrene-Butadiene and Styrene-Acrylic Latices in Paper Coating Applications” (http://worldaccount.basf.com) gives the general teaching how a number of latex parameters can be adjusted to optimize the binding power of the polymer. Hayes discloses that a decrease in the particle size of a styrene-butadiene or styrene-acrylic latex will produce an increase in coating strength. This is assumed to be the result of an increase in the total number of latex particles available in a given formulation. Further, Hayes discloses that the strongest styrene-butadiene binders have a small particle size and optimized gel content, glass transition temperature (T_{g}), and acid content.

One of the problems related to the coating by the dry surface treatment process is the behavior of the polymeric binder material during the process. Typically synthetic paper coating binders (latexes) have a particle size between 100-150 nm and the glass transition temperature (T_{g}) is from −35° C. to +35° C. The binder dosage being typically between 10-15 parts per 100 parts inorganic pigment. Typically coatings are produced by mixing the pigments and binder together with water. The resulting mixture is then dried and dry ground to produce a dry coating powder. The use of these known coating powders results in coatings having a quality that is unacceptable for high speed printing.

Pick is the name commonly given to damage to the paper surface occurring during the printing operation. When the printing form is lifted from the paper, the ink exerts on the paper a force, which increases with increasing viscosity and tack of the ink and with increasing printing speed. When this force exceeds a critical value, which depends on the paper, the surface of the paper is damaged. The minimum printing speed at which pick occurs is a measure of the pick resistance of the paper. Pick velocity [m/s] is the velocity at which pick of the surface on the printed paper begins under the conditions defined in the International standard ISO 3783 (IGT type tester). This pick resistance measurement can be used to describe the surface strength of the paper.

In the book series of Papermaking Science and Technology, Book 11 “Pigment Coating and Surface Sizing of Paper” discloses on page 210 that it is well known that dry pick strength increases with decreasing particle size of latexes and increasing latex carboxylation. Thus, it is generally believed that the smaller the particle size of the binder the better coating strength will be. However, the known coating compositions do not have a surface strength that is high enough, even if small particle size binders are used (i.e. below 150 nm), and because of economical reasons it is not reasonable to raise the surface strength by increasing binder dosage, there is a need for the development of new dry coating powders for improving the surface strength.

### DESCRIPTION OF THE INVENTION

An object of the present invention is thus to provide a binder material so as to alleviate the above disadvantages. The objects of the invention are achieved by a dry coating binder, a dry coating composition and coating process, which are characterized by what is stated in the independent claims. The preferred embodiments of the invention are disclosed in the dependent claims.

The invention is based on the realization that by the right selection of polymeric binder for coating powder the final coating quality (surface strength) can be improved. In dry coating experiments it was found out that customized binders were better than commercial available binders. Especially it was realized that the particle size of the binder is a determinant factor of the final surface strength of the coating. Against the general knowledge in the field of the art, it was surprisingly found out that a bigger particle size than normally used gave better surface strength.

The present invention provides a binder comprising a synthetic polymer and having a specific particle size. The lower limit of the particle size is 200 nm, but in some embodiments of the invention the lower limit of the particle size may be 220 nm, 240 nm or even 250 nm. The upper limit of the particle size is 400 nm, but in some embodiments of the invention the upper limit of the particle size may be 350 nm, 320 nm or 300 nm. It should be clear for a person skilled in the art that the binder may contain some small portions of fine particles having a particle size below 200 nm, but that the binder of the present invention comprises substantially only particles within the above-mentioned particle size limits.

The particle size should not be too large because then the dispersion does not maintain stability as well as when the upper limit of the particle size is set to 400 nm. The big particles sediment more easily and they also may form agglomerates, which would increase the sedimentation.

The binder of the invention is especially useful in dry coating powder compositions for coating a web of paper. The inventors have surprisingly found out that particle size of the binder has a great impact on the IGT surface strength of dry coated papers. Typically synthetic paper coating binders have particle size between 50-150 nm and the glass transition temperature (T_{g}) is from −35° C. to +35° C. The excellent results of the present invention were obtained with binders having bigger particle size than typically. In this application by “particle size” is meant the mean particle size of the polymerized particles.

The dry coating binder of the present invention is characterized by the particle size of the binder, which is between 200-400 nm, preferably between 220-350 nm, and more preferably between 250-350 nm. Suitable binders are synthetic polymers, in particular polymers which are obtainable by free radical polymerization of ethylenically unsaturated compounds (monomers). Preferably the polymers are prepared by emulsion polymerization, and an emulsion polymer is therefore involved. Other possible preparation methods include suspension polymerization and subsequent dispersing in water.

The dry coating binder of the present invention is a polymer which comprises at least 80% by weight of so-called main monomers. In some embodiments the amount of main monomers can be at least 90% by weight or at least 95% by weight. The main monomers are selected from C₁-C₂₀-alkyl (meth)acrylates, C₁-C₂₀-hydroxy alkyl (meth)acrylates, C₁-C₂₀-alkyl (meth)acrylamides, C₁-C₂₀-hydroxy alkyl (meth)acrylamides, vinyl esters of carboxylic acids comprising up to 20 carbon atoms, vinyl aromatics having up to 20 carbon atoms, ethylenically unsaturated nitriles, vinyl ethers of alcohols comprising 1 to 10 carbon atoms, aliphatic hydrocarbons having 2 to 8 carbon atoms and one or two double bonds, or mixtures of these monomers.

For example, alkyl (meth)acrylates having a C₁-C₁₀-alkyl radical, such as methyl methacrylate, methyl acrylate, butyl acrylate, ethyl acrylate, and 2-ethylhexyl acrylate, may be mentioned. In particular, mixtures of the alkyl (meth)acrylates are suitable.

Vinyl esters of carboxylic acids having 1 to 20 carbon atoms are, for example, vinyl laurate, vinyl stearate, vinyl propionate, vinyl versatate, and vinyl acetate. It is also possible that the vinyl esters have been hydrolyzed to alcohols in the final polymer, thus forming polyalcohols. Suitable vinyl aromatic compounds are styrene, vinyltoluene, α- and p-methylstyrene, α-butylstyrene, 4-n-butylstyrene, and 4-n-decylstyrene, styrene being a preferred main monomer.

Examples of nitriles are acrylonitrile and methacrylonitrile. For example, vinyl methyl ether or vinyl isobutyl ether may be mentioned as vinyl ethers. Vinyl ethers of alcohols comprising 1 to 4 carbon atoms are preferred. Ethylene, propylene, butadiene, isoprene and chloroprene may be mentioned as examples of hydrocarbons having 2 to 8 carbon atoms and one or two olefinic double bonds.

Preferred main monomers are C₁-C₁₀-alkyl (meth)acrylates, in particular butyl acrylate, and mixtures of the alkyl(meth)acrylates with vinyl aromatics, in particular styrene, or, alternatively, hydrocarbons having 2 double bonds, in particular butadiene, or mixtures of such hydrocarbons with vinyl aromatics, in particular styrene.

In the case of mixtures of aliphatic hydrocarbons (in particular butadiene) with vinyl aromatics (in particular styrene), the ratio may be, for example, from 10:90 to 90:10, in particular from 20:80 to 80:20.

In addition to the main monomers, the polymer may comprise monomers having at least one acid group, for example monomers having carboxylic, sulfonic or phosphonic acid groups. Carboxylic groups are preferred. For example, acrylic acid, methacrylic acid, itaconic acid, maleic acid, crotonic acid, fumaric acid, 2-acrylamido-2-methyl propanesulfonic acid (AMPS), vinyl sulfonic acid, and vinyl phosphonic acid may be mentioned. In the final polymer the acids may be also in the corresponding salt form.

Further monomers over and above these are, for example, monomers comprising hydroxyl groups, in particular C₁-C₁₀-hydroxyalkyl (meth)acrylates, and (meth)acrylamide.

The main monomers preferably comprise acid monomers as comonomers, preferably in an amount of from 1% to 6% by weight.

In one embodiment of the present invention, the dry coating binder is a styrene/butyl acrylate/acrylic acid copolymer (S/BA/AA). Said S/BA/AA copolymer has been preferably polymerized with the following monomer ratio:
a) 34 to 90 parts, more preferably 60 to 75 parts by weight styrene,
b) 5 to 65 parts, more preferably 15 to 35 parts by weight butyl acrylate, and
c) 1 to 5 parts, more preferably 2 to 4 parts by weight acrylic acid.

In the case of the emulsion polymerization, ionic and/or nonionic emulsifiers and/or protective colloids can be used as stabilizers. Typically the surface-active substances are used in amounts of from 1% to 5% by weight, based on the monomers to be polymerized. It is an advantage of the present invention that the amount of surface-active substances may be decreased. In some embodiments of the present invention, it is advantageous that the amount of surface-active substances is less than 1% or less than 0.5% or even less than 0.2% and preferably less than 0.15% by weight based on the monomers to be polymerized. One example of surface active substance is sodium dodecyl sulfate (SDS) other examples of possible surface active substances are, but not limited to, sodium dodecanoate, sodium tetradecanoate, sodium hexadecanoate, sodium octadecanoate, sodium tetradecyl sulfate, sodium hexadecyl sulfate, sodium octadecyl sulfate, sodium dodecyl sulfonate, sodium dodecyl benzene sulfonate, sodium dialkyl sulfosuccinates, polyoxyethylene dodecyl ethers, and polyoxythylene nonyl phenyl ethers.

Instead of surfactants it is also possible to use protective colloids, such as polyvinylalcohol (PVA), starch or carboxymethyl cellulose (CMC).

Water-soluble initiators for the emulsion polymerization are, for example, ammonium and alkali metal salts of peroxodisulfuric acid, e.g. potassium persulfate (K₂S₂O₈), sodium persulfate (Na₂S₂O₈), hydrogen peroxide or organic peroxides, e.g. tert-butyl hydroperoxide. So-called reduction-oxidation (redox) initiator systems are also suitable. The amount of the initiators is in general from 0.1% to 10% by weight, preferably from 0.2% to 4% by weight, based on the monomers to be polymerized. It is also possible to use a plurality of different initiators in the emulsion polymerization.

Chain length regulators can be used in the polymerization, for example in amounts of from 0 to 0.8 part by weight, based on 100 parts by weight of the monomers to be polymerized, the molar mass being reduced by the said regulators. For example, compounds having a thiol group, such as tert-butyl mercaptan, thioglycolic acid, mercaptoethanol, mercaptopropyltrimethoxysilane or tert-dodecyl mercaptan, are suitable.

The emulsion polymerization is effected, as a rule, at from 30° C. to 130° C., preferably from 50° C. to 90° C. The polymerization medium may consist either only of water or of mixtures of water with liquids miscible therewith, such as methanol. Preferably, only water is used. The emulsion polymerization can be carried out both as a batch process and in the form of a feed process, including a step or gradient procedure. The feed process in which a part of the polymerization batch is initially taken, heated to polymerization temperature and partly polymerized and then the remainder of the polymerization batch is fed to the polymerization zone, usually via a plurality of spatially separate feeds, one or more of which comprises the monomers in pure or in emulsified form, continuously, stepwise or with superposition of a concentration gradient, while maintaining the polymerization, is preferred. In the polymerization, a polymer seed may also be initially taken, for example for better adjustment of the particle size.

The manner in which the initiator is added to the polymerization vessel in the course of the free radical aqueous emulsion polymerization is known to the average person skilled in the art. It can either be completely initially taken in the polymerization vessel or used continuously or stepwise at the rate of its consumption in the course of the free radical aqueous emulsion polymerization. Specifically, this depends on the chemical nature of the initiator system and on the polymerization temperature. Preferably, a part is initially taken and the remainder is fed to the polymerization zone at the rate of consumption.

In order to remove the residual monomers, the initiator is usually also added after the end of the actual emulsion polymerization, i.e. after a conversion of at least 95% of the monomers.

In the feed process, the individual components can be added to the reactor from above, at the side or from below through the reactor bottom. In the emulsion polymerization, aqueous dispersions of the polymer generally having solids contents of from 15 to 75% by weight, typically from 40 to 55% by weight, are obtained.

By changing the ratio of monomers in the formulation the T_{g} changes. In one embodiment of the invention the T_{g} of the polymer is between −25° C. to 95° C. Variation of T_{g} can be used to optimize the binder. The T_{g} of the binder may be adjusted within the predetermined limits. For example the lower limit of the T_{g} of the binder according to the present invention may be −25° C., 0° C., 10° C., 15° C., 20° C., or 25° C. and the upper limit of the T_{g} of the binder according to the present invention may be 95° C., 80° C., 70° C., 60° C., 50° C., or 40° C.

According to Fox (T. G. Fox, Bull. Am. Phys. Soc. (Ser. II) 1 (1956) 123), the glass transition temperature of copolymers is given, to a close approximation, by:

$$\frac{1}{Tg} = \frac{{X}^{1}}{{Tg}^{1}} + \frac{{X}^{2}}{{Tg}^{2}} + … \frac{{X}^{s}}{{Tg}^{s}}$$

where X¹, X², . . . , X^{s} denote the proportions by weight of monomers 1, 2, . . . , s, and T_{g}¹, T_{g}², . . . , T_{g}^{s} denotes the glass transition temperatures of the respective polymers built up only from one of the monomers 1, 2, . . . , s, in Kelvin. The glass transition temperatures of some of the monomers are essentially known and are listed, for example, in Emulsion Polymerization and Emulsion Polymers, ed. Lovell and Al-Aasser, p. 622.

As mentioned regulators such as sodium dodecyl sulfate (SDS) can be used in the polymerization to adjust the mean particle size. The amount of SDS is preferably from 0.05 wt-% to 0.5 wt-% based on the monomers to be polymerized. The particle size changes depending on how much SDS is charged to the reactor, but also the speed of the agitator affects the particle size. Higher agitator speed degreases the mean particle size.

The binder of the present invention is preferably a styrene/butyl acrylate/acrylic acid copolymer (S/BA/AA), containing 60 to 76 parts by weight styrene, 15 to 35 parts by weight butyl acrylate, and 2 to 4 parts by weight acrylic acid. During the polymerization the solid content is preferably 40 wt-% to 45 wt-%, and as the initiator potassium persulfate (K₂S₂O₈) is used in an amount of 0.25 wt-% to 0.5 wt-% based on the monomers to be polymerized.

By changing T_{g} and particle size of the binder it is possible to find out the binder with the substantially improved properties. The surface strength of the coated paper is very good when using the binder of the present invention having the mean particle size between 250 nm and 350 nm.

The results show that the IGT surface strength value in all experiments having acrylic acid content of 2 wt-% and particle size between 250 and 320 nm was above 1, which is much higher than the results obtained from samples having particle size below 200 nm or above 350 nm. Also in samples having acrylic acid content of 4 wt-% the IGT surface strength value was much higher when the particle size was 292 nm than when the particle size was below 200 nm.

The results clearly show that the particle size of the binder before mixing with the pigment particles is a determinant factor of the final surface strength of the coating. Against the general knowledge in the field of the art, increasing the particle size to a certain point improved the surface strength. It could be noticed that the IGT value was not linearly dependent on the particle size, but that a specific optimized particle size between 200 and 350 nm gave the best results.

As a second aspect the present invention provides the use of the binder composition according to the invention in a paper or board coating composition. In one embodiment of the invention the paper coating composition is in powder form and is applied on the paper using dry coating technology. By using the polymeric binder composition of the present invention in a coating powder the final coating quality, namely the surface strength, can be improved.

As a third aspect the present invention provides a coating composition comprising inorganic particles and the binder of the present invention. Such a coating composition may contain inorganic particles, such as crystalline or amorphous aluminum hydroxides, natural or synthetic calcium carbonate, for example chalk, calcite, marble or any other form of calcium carbonate, natural or synthetic precipitated silicates, calcium sulfate, titanium dioxide, satin white, talcs, micas, clays, calcined clays, zinc oxide and mixtures thereof. Further, the composition may comprise a mixture of mineral and plastic pigments. In one embodiment of the invention the amount of the plastic pigment is 0.1-20% by weight of the amount of the inorganic particles. The coating composition may also comprise coloring pigments and/or carbon black.

The coating composition may be produced by mixing the binder with inorganic particles. In one embodiment of the invention the binder dosage is between 5-20 parts per 100 parts inorganic particles and typically being between 10-15 parts per 100 parts inorganic particles. The mixing can be performed with or without additional water. After mixing the obtained mixture is dried by a convenient manner such as spray drying or freeze drying. The dry mixture is then ground for example with a jet mill and then the coating composition is recovered in dry powder form. The obtained coating powder can be used for coating a paper substrate in a dry coating method. The coating composition may also comprise other additives, such as optical brightening agent or antiblocking agent.

As a fourth aspect the present invention provides a process for coating a web of paper by a dry coating powder, the process being characterized in that it comprises a step of applying a coating composition of the invention to at least one side of the web using known dry coating methods.

The invention will now be illustrated with the aid of some non-limiting examples.

### EXAMPLES

### Example 1

### Polymerization

Thermoplastic binders according to the invention were emulsion polymerized. Polymerizations were made in a 700 ml glass reactor. Nitrogen was fed into the reactor during polymerization. A glass agitator with 3 blades was used. The reactor was placed in a water bath. The temperature of the bath was 80° C. All the binder samples were polymerized in this reactor. The polymerization time was 6 hours. After this the water was removed from the bath. Then during 3 hours the sample in the reactor was cooled to room temperature, after this the agitation was stopped. The agitation speed during cooling was the same as during polymerization from 4 h30 min to 6 h.

During the polymerization, the speed of the agitator can be varied depending on the desired mean particle size. The agitation speed was 175 rpm during the first 4 h 30 min from the beginning of the polymerization, and 250 rpm during the next 1.5 hours (from 4 h 30 min to 6 h) for all the polymerizations except for Sample 011 for which the agitation speeds were 220 rpm and 310 rpm respectively.

### Formulation

The monomers were: styrene, n-butyl acrylate and acrylic acid. The formulation of the polymerized binders is disclosed in Table 1. The amount of styrene varied from 59.8 wt-% to 71 wt-%, the amount of n-butyl acrylate varied from 27 wt-% to 38.2 wt-%, and the amount of acrylic acid varied from 2 wt-% to 4 wt-%. The solid content was 42.5 wt-% in all polymerizations.

Sodium dodecyl sulfate (SDS) was used to adjust the mean particle size. The amount of SDS was from 0.09 wt-% to 0.17 wt-% based on the monomers to be polymerized. Initiator potassium persulfate (K₂S₂O₈) was added 0.39 wt-% based on the monomers to be polymerized.

### Sample 002

Sample 002 was polymerized in the 700 ml reactor. Nitrogen was fed into reactor during polymerization. Following chemicals were added into the reactor: styrene 6.1 g, n-butyl acrylate 2.3 g and acrylic acid 0.17 g, SDS 0.25 g (0.12 wt-%) and water 248.2 g, Potassium persulfate 0.20 g and water 8.8 g. The polymerization was continued for 10 minutes. Then the addition of following chemicals into the reactor was started and continued during 300 minutes:
1) styrene 143.6 g and n-butyl acrylate 54.6 g;
2) acrylic acid 4.0 g and water 18.1 g; and
3) potassium persulfate 0.61 g and water 12.5 g.

When the addition was finished, the reaction continued during 1 hour. Then the cooling of the sample in the reactor started. The water was removed from the bath. The sample in the reactor was allowed to cool slowly to room temperature. During cooling the agitator was rotating for 3 hours.

The sample was filtered through a filter cloth 50 μm. The quantity of the lumped polymers that was carried on the filter was weighted. The mean particle size and the T_{g} were analyzed. The particle size changes depending on how much SDS is charged to the reactor, but also the speed of the agitator affects the particle size. By changing the ratio of monomers in the formulation the T_{g} changes.

The other samples were polymerized in a similar manner. The results are summarized in Table 1.

### Example 2

The obtained polymers from Example 1 were used together with pigments in coating powders. The polymers obtained were neutralized with ammonium hydroxide before mixing with pigments. The coating powders were used in paper dry coating.

First the coating powders (Table 1) were formed from the raw materials. This was done by mixing 15 parts of experimental binders with 100 parts GCC pigment (particle size: 90% less than 2 microns) in water state.

The mixtures were freeze dried and micronized in a fluidized bed jet mill of the type Alpine AFG 100. Powders thus obtained having a particle size D90 2.5-5.5 μM were applied on paper substrate (base paper 37 g/m²) using Nordson Versa Spray II manual spray gun. The coat weights varied between 5-11 g/m².

The fixing of coating powder on a base paper was done by thermo-mechanical treatment using a laboratory calender (DT Paper Science; heated steel roll, polymer covered backing roll). In fixing each sample was run through four calender nips with the following condition. The first three nips: the calendering speed 4 m/min, the temperature of the heated roll was 150° C. and the nip load 64 kN/m. Siliconised baking paper was used to prevent sticking onto the hot calender roll. The last fixing nip was done without siliconised baking paper in the calendering speed 4 m/min, the temperature of the heated roll was 150° C. and the nip load 164 kN/m.

The coating quality (IGT surface strength) of the dry coated papers was then analyzed. The experimental binders were styrene/n-butylacrylate/acrylic acid copolymers (S/BA/AA) with varied particle size and glass transition temperature (T_{g}) as shown in Table 1.

The effect of binder particle size and T_{g} on the IGT surface strength (dry coated papers) can be seen in Table 1. For the S/BA/AA binder it was observed that optimum particle size is between 250-350 nm in terms of IGT surface strength.

TABLE 1
The formulation of the polymerized binders and analysis results

| | | Particle | Monomer | | Agita- | Agita- | |
|---|---|---|---|---|---|---|---|
| Sam- | | size | ratio | SDS | tion | tion | |
| ple | T_{g} | (nm) | S/BA/AA | (wt-%) | speed I | speed II | IGT |
| 001 | 54 | 194 | 71/27/2 | 0.17 | 175 | 250 | 0.77 |
| 002 | 53 | 278 | 71/27/2 | 0.12 | 175 | 250 | 1.03 |
| 003 | — | 306 | 71/27/2 | 0.10 | 175 | 250 | 1.01 |
| 004 | — | 450 | 71/27/2 | 0.09 | 175 | 250 | 0.91 |
| 005 | — | 117 | 75/21/4 | 0.17 | 175 | 250 | 0.74 |
| 006 | 53 | 190 | 70/26/4 | 0.09 | 175 | 250 | 0.82 |
| 007 | 49 | 292 | 70/26/4 | 0.07 | 175 | 250 | 0.95 |
| 008 | 28 | 250 | 59.8/38.2/2 | 0.12 | 175 | 250 | 1 |
| 009 | 31 | 320 | 60.5/37.5/2 | 0.12 | 175 | 250 | 1.05 |
| 010 | 43 | 250 | 66/32/2 | 0.12 | 175 | 250 | 1.03 |
| 011 | 43 | 65 | 66/32/2 | 0.80 | 220 | 310 | 0.64 |
| 012 | 48 | 260 | 68.5/29.5/2 | 0.12 | 175 | 250 | 1.07 |

IGT = Pick velocity [m/s], the velocity at which pick of the surface on the printed paper begins under the conditions defined in the International standard ISO 3783 (IGT type tester). Test performed using IGT AIC2-5T2000 by IGT Testing Systems with low viscosity oil.
SDS = The amount of Sodium dodecyl sulfate based on the monomers to be polymerized.

Particle sizes were measured using photon correlation spectroscopy with a Zetamaster device (Malvern Instruments, Finland). The accuracy of the device was tested using the following polystyrene standards: Duke Scientific Corporation, 3020 A (20 nm) and 3100 A (100 nm).

The glass transition (T_{g}) determinations were carried out according to the ASTM E1356-03 Standard Test Method for Assignment of the Glass Transition Temperatures by Differential Scanning calorimetry using Mettler Toledo DSC821 instrument, calibrated against indium and zinc. The temperature range of the dynamic experiment was heating from 0° C. to 100° C. at the rate of 5° C./min and then after cooling back to 0° C. the heating was repeated. The glass transition temperature was determined by the second heating curve. Aluminum crucibles and sample weights of about 20 mg were used.

By changing T_{g} and particle size it was possible to find out the binder with the substantially improved properties. The surface strength of the coated paper showed very good results, for the developed thermoplastic binder with the mean particle size 260 nm and T_{g} 48° C. (IGT 1.07 m/s).

The results show that the IGT surface strength value in all experiments having an acrylic acid content of 2 wt-% and a particle size between 250 and 320 nm was above 1, which is much higher than the results obtained from samples having a particle size below 200 nm or above 350 nm. Also in samples having an acrylic acid content of 4 wt-% the IGT surface strength value was much higher when the particle size was 292 nm than when the particle size was below 200 nm.

The results clearly show that the particle size of the binder before mixing with the pigment particles is a determinant factor of the final surface strength of the coating. Against the general knowledge in the field of the art, increasing the particle size to a certain point improved the surface strength. It could be noticed that the IGT value was not linearly dependent on the particle size, but that a specific optimized particle size between 250 and 350 nm gave the best results.

1-22. (canceled)

23. Dry coating binder comprising a polymer which comprises at least 80% by weight of main monomers, wherein the polymer is a S/BA/AA copolymer, wherein the main monomers are styrene (S) and butyl acrylate (BA), and the additional monomer is acrylic acid (AA) or the polymer has main monomers being vinyl esters of carboxylic acids comprising up to 20 carbon atoms and hydrolyzed to alcohols, or the polymer is a mixture of these., and that the particle size of the binder is between 200-400 nm.

24. Dry coating binder according to claim 23, wherein the particle size of the binder is between 250-350 nm.

25. Dry coating binder according to claim 23, wherein the S/BA/AA copolymer has been polymerized with a monomer ratio of:
a) 34-90 parts by weight styrene
b) 5-65 parts by weight butyl acrylate, and
c) 1-5 parts by weight acrylic acid.

26. Dry coating composition comprising inorganic particles and at least one binder, wherein at least one binder is a dry coating binder according to claim 23.

27. Dry coating composition according to claim 26, wherein the inorganic particles are mineral pigments.

28. Dry coating composition according to claim 26, wherein the inorganic particles are selected from the group consisting of crystalline or amorphous aluminum hydroxides, natural or synthetic calcium carbonates, natural or synthetic precipitated silicates, calcium sulfate, titanium dioxides, satin white, talcs, micas, clays, calcined clays, zinc oxide and mixtures thereof.

29. Dry coating composition according to claim 26, wherein the composition comprises a mixture of mineral pigments and plastic pigments.

30. Dry coating composition according to claim 29, wherein the coating composition contains a plastic pigment in an amount of 0.1-20% by weight of the amount of the inorganic particles.

31. Dry coating composition according to claim 26, wherein the binder dosage is between 5-20 parts per 100 parts inorganic particles.

32. Method of improving the surface strength of coated paper, which comprises using a dry coating binder in a paper or board coating composition, wherein the paper coating composition is in powder form and is applied on the paper using dry coating technology, the binder comprising a polymer which comprises at least 80% by weight of main monomers, the main monomers being selected from C₁-C₂₀-alkyl (meth)acrylates, C₁-C₂₀-hydroxy alkyl (meth)acrylates, C₁-C₂₀-alkyl (meth)acrylamides, C₁-C₂₀-hydroxy alkyl (meth)acrylamides, vinyl esters of carboxylic acids comprising up to 20 carbon atoms, vinyl aromatics having up to 20 carbon atoms, ethylenically unsaturated nitriles, vinyl ethers of alcohols comprising 1 to 10 carbon atoms, aliphatic hydrocarbons having 2 to 8 carbon atoms and one or two double bonds or mixtures of these monomers, and that the particle size of the binder is between 200-400 nm.

33. The method of claim 32, wherein the particle size of the binder is between 250-350 nm.

34. The method of claim 32, wherein the vinyl esters have been hydrolyzed to alcohols in the final polymer.

35. The method of claim 32, wherein the main monomers are selected from a group consisting of
a) methyl methacrylate, methyl acrylate, butyl acrylate, ethyl acrylate and 2-ethylhexyl acrylate;
b) vinyl laurate, vinyl stearate, vinyl propionate, vinyl versatate and vinyl acetate;
c) styrene, vinyl toluene, α- and p-methylstyrene, α-butylstyrene, 4-n-butylstyrene and 4-n-decylstyrene;
d) acrylonitrile and methacrylonitrile;
e) vinyl methyl ether and vinyl isobutyl ether; and
f) ethylene, propylene, butadiene, isoprene and chloroprene.

36. The method of claim 32, wherein in addition to the main monomers, the polymer comprises monomers having at least one acid group.

37. The method of claim 36, wherein the acid groups are carboxylic, sulfonic, phosphoric or phosphonic acid groups.

38. The method of claim 36, wherein the monomers having at least one acid group are selected from the group consisting of acrylic acid, methacrylic acid, itaconic acid, maleic acid, crotonic acid, fumaric acid, 2-acrylamido-2-methyl propanesulfonic acid (AMPS), vinyl sulfonic acid, and vinyl phosphonic acid.

39. The method of claim 36, wherein the amount of monomers having at least one acid group is from 1 to 6% by weight of monomers.

40. The method of claim 32, wherein the polymer is a S/BA/AA copolymer, wherein the main monomers are styrene (S) and butyl acrylate (BA), and the monomer having at least one acid group is acrylic acid (AA).

41. The method of claim 40, wherein the S/BA/AA copolymer has been polymerized with a monomer ratio of:
a) 34-90 parts by weight styrene
b) 5-65 parts by weight butyl acrylate, and
c) 1-5 parts by weight acrylic acid.

42. A process for coating a web of paper with a dry coating powder, which comprises a step of applying a coating composition according to claim 26 to at least one side of the web.

43. A method for preparing a dry coating binder according to claim 23, which comprises emulsion polymerization of the monomers.

44. A method according to claim 43, wherein the particle size of the dry coating binder is adjusted by the amount of agitation speed in the polymerization reactor and by the amount of surface-active substances.

45. A method according to claim 44, wherein sodium dodecyl sulfate is used as the surface-active substance in an amount of less than 1%, preferably less than 0.5%, and more preferably less than 0.15% by weight based on the monomers to be polymerized.
